(19) United States
(12) Patent Application Publication
(10) Pub. No.: US 2019/0027005 A1
(43) Pub. Date: Jan. 24, 2019

(54) HOME MONITOR

(71) Applicant: Practecol, LLC, St. Louis, MO (US)

(72) Inventor: Greg Siwak, Clayton, MO (US)

(21) Appl. No.: 16/040,217

(22) Filed: Jul. 19, 2018

Related U.S. Application Data
(63) Continuation of application No. 29/611,225, filed on Jul. 19, 2017.
(60) Provisional application No. 62/534,473, filed on Jul. 19, 2017.

(51) Int. Cl. G08B 13/196; G08B 26/00

(52) U.S. Cl. CPC G08B 13/19628; G08B 26/008; G08B 13/19695; G08B 13/19684

(57) ABSTRACT

A security system which is designed to provide for 360 degree viewing to allow for the real-time recording of relevant video without the need to rotate a camera into position. The system also provides for the ability to rapidly interpret and refine the image from the 360 degree camera into a format where a human user can rapidly interpret what they are looking at and react to it. In particular, the system allows for quick scanning through the 360 degree image by the user, but also it allows for an immediate focus of the user to a more readily understandable trigger image which is indicative of why the system activated.

### CROSS REFERENCE TO RELATED APPLICATION(S)

This application claims the benefit of U.S. Provisional Patent Application Ser. No. 62/534,473, filed Jul. 19, 2017 and currently pending, and is a Continuation-in-Part (CIP) of U.S. Design patent application No. 29/611,225, filed Jul. 19, 2017 and currently pending. The entire disclosure of both these documents is herein incorporated by reference.

### BACKGROUND

### 1. Field of the Invention

This disclosure is related to the field of monitoring and intrusion detection, and more specifically to an intrusion monitor useable without the need to install electronics into a residence which can utilize a 360 degree field of view.

### 2. Description of Related Art

Burglary is generally defined as breaking into a residence or other structure in order to commit theft. It is often a crime of opportunity, where a potential burglar locates an empty residence through a variety of measures and then enters the residence to take available money and easily sellable materials such as electronics and jewelry.

Burglary has been defined as criminal since the very first written criminal laws existed and is more prevalent than many people realize. It has been estimated that a burglary occurs in the United States every 15 seconds and that one in thirty-five homes will be burglarized in any given year. Burglary generally presents both a loss of property (with a value generally around $1500) and, often, a loss of far more. Having a home burglarized can result in loss of feelings of comfort or security and physical damage to the residence in addition to the loss of the items stolen.

While burglary is quite common, it is also reasonably easy to defeat. Any system which makes breaking into a residence take longer, or more likely to be detected, will often result in a burglary deterrence and, therefore, a potential burglar will pass on one residence in favor of an easier target. For this reason, homeowners regularly utilize all sorts of different deterrents including, but not limited to, sophisticated electronic burglary systems, automatic lighting systems, and even dogs to deter would-be-burglars.

As effective as current electronic systems can be, many of them share common problems. For example, they are often not readily useable in temporary or rental housing, they are expensive to install, and they require the presence of a third party monitoring company. In many respects, the technology of the current electronic intrusion alarm is based around technology which is from a prior generation. In today's modern era, the consumer is more mobile, both in their housing with rental and temporary property being utilized to a greater extent, and in their person where computer technology that a decade ago was confined to the desktop is now being carried with them. Even with all these changes, however, the electronic security system is little changed from what it was years ago.

In addition to the technology, the attitude of the modern consumer has also changed. The modern consumer is used to products which give them control as opposed to products being controlled by a third party. Fountain drink dispensers have come out from behind the counter, the gas station attendant has been replaced by an in-pump credit card reader, and people can get information on anything and everything from their smartphones. The electronic security system, however, is still firmly grounded in the notion that security is best handled by professionals, even when there is no such need. In today's world there is demand for security systems that can be used anywhere the consumer may be located, whether it is in permanent housing, temporary housing, a hotel room, or even in a camper or their car without them needing to sign a multi-year contract to use it.

In effect, the intrusion alarm as a capital improvement in the form of a fixture attached to a residence is no longer a necessarily desirable upgrade to a residence. This is much the same way that the advent of digital music distribution has rendered the built-in CD player almost a hindrance instead of a benefit. Where it used to be that the presence of an installed security system could increase a home's resale value even though the new owner would still need to pay for the service to make it useful, such systems are no longer of interest to many buyers who would rather have control over who their security provider is, and particularly to eliminate the expense and hassle of having a security provider at all when they can handle the monitoring of the system themselves. In effect, many security systems are nothing other than installed wasted hardware.

This new self-help society has led to an influx of security or monitoring systems that allow for a resident to monitor their residence directly. These systems are generally in the form of cameras that provide for the ability to record a burglary, and with the recording, deter the criminal or assist in their apprehension. Generally, the products can be described as coming in two particular forms of system. The first form is a very small camera with an onboard memory. These systems have the advantage of being very small and self contained, but are problematic because they generally cannot provide any notification of a burglary in progress as they do not have the power or infrastructure to communicate externally. They generally can simply record what happens for later use as evidence. This means that systems of this type have to be hidden or else a burglar will be able to locate them and take the memory (and the evidence) with them. As such, these types of system are more often used for discrete monitoring than for theft deterrence.

To deal with this problem, the second types of system will essentially live stream the video they are taking to a remote device. These types of systems have the advantage that even if the system is relatively quickly dismantled in a burglary attempt, the video is generally stored remotely and, therefore, the burglar cannot destroy the stored video by destroying the camera which is often enough video to provide for evidence and alert. One of many problems with the second type of system, however, is making sure that the system detects and transmits video of the activity of interest quickly enough that it captures valuable imagery of the target even if the target knows the system is present, and attempts to avoid it or immediately disable it.

A second problem is in dealing with a human interpreter of the video. In many jurisdictions, security systems are not allowed to be automated and even where they are allowed, an owner of the system is generally not interested in having an automated system. The reason is simple. While the systems are very good at catching unauthorized activity, they will often trigger a number of false alarms and may trigger even if the activity is known about and authorized simply so that the systems remain active when they are needed.

Most commonly, these scenarios present possible false alarms because the systems automatically treat any motion activated image capture, motion detection, or related “trigger” situation as a situation requiring emergency response to make sure they “fail safe”. A user of the system, however, may be liable for costs associated with false alarms and therefore, these types of triggers can be far more sensitive than desired. To deal with this, sensitivity is often turned down and the systems require increasingly complex electronic overhead to automatically evaluate trigger events in more detail before issue an alert. This is inefficient and expensive and it is often best to have the imagery captured and reviewed by a human.

However, in standard security systems, this also adds expense as the reviewer is a third party. Instead, it is desirable for a person directly involved in the residence, generally the owner of the security system or resident but not necessarily, to make sure that sending an alert is appropriate. A human actor, particularly if they are the individual liable if there is a false alarm is often the best to make a judgement call as to whether or not to obtain an emergency response.

At the same time, the human actor needs information and they need it very quickly. The need for speed in the capture of imagery, the transmission of the imagery to a remote site, and the human processing of the imagery is paramount. If a security system operates too slowly, a legitimate alert may arrive too late or be too hard to interpret for it to be valuable. It takes a non-zero amount of time for the system to react, start transmitting video, for the video to be reviewed and acted upon, and for first responders to arrive after an alert is sent. If these steps take too long, the activity that the system is designed to inhibit may be completed before responders can arrive or, depending on how the system is configured to record, the system may be disabled before it can record or transmit (and remotely record) valuable data.

### SUMMARY

Because of these and other problems in the art, described herein, among other things, is a security system which is designed to provide for 360 degree viewing to allow for the real-time recording of relevant video without the need to rotate a camera into position. This can help accelerate the ability to capture relevant video very quickly after the system is activated as any video within line of sight of the lens is captured as soon as image capture begins. The system also provides for the ability to rapidly interpret and refine the image from the 360 degree camera into a format where a human user can rapidly interpret what they are looking at and react to it. In particular, the system allows for quick scanning through the 360 degree image by the user, but also it allows for an immediate focus of the user to a more readily understandable trigger image which is indicative of why the system activated.

There is described herein among other things, a security system comprising: a monitor including: a wide angle lens, said lens being positioned so that a center of an image generated by said lens is generally above said monitor and a periphery of said image generated by said lens displays a 360 degree view in a horizontal plane about said monitor; a communication system; and a plurality of detection apparatus arranged about said monitor so that activation of any particular subset of said plurality of detection apparatus is associated with a known area of said periphery of said image; and a video viewing device, remote from said monitor; wherein upon activation of a subset of said plurality of detection apparatus, said monitor utilizes said communication system to transmit said image generated by said lens to said video viewing device; wherein said video viewing device receives said image generated by said lens, and displays only said known area of said periphery of said image.

There is also described herein a method of implementing the above and other computer programs, systems, and means for operating and constructing a security system with similar capabilities.

In an embodiment of the security system, the plurality of detection apparatus includes at least one motion detector.

In an embodiment of the security system, the plurality of detection apparatus includes at least one audio detector.

In an embodiment of the security system, the video viewing device comprises a mobile device.

In an embodiment of the security system, the mobile device comprises a smartphone.

In an embodiment of the security system, the mobile device comprises a tablet computer.

In an embodiment of the security system, the lens comprises a fisheye lens.

In an embodiment of the security system, the lens has a field of vision of at least 180 degrees around a vertical axis relative to said horizontal plane.

In an embodiment of the security system, the lens has a field of vision of at least 200 degrees around a vertical axis relative to said horizontal plane.

In an embodiment of the security system, the lens has a field of vision of at least 210 degrees around a vertical axis relative to said horizontal plane.

In an embodiment of the security system, the video viewing device dewarps said known area of said periphery of said image before displaying it.

In an embodiment of the security system, the video viewing device enlarges said known area of said periphery of said image before displaying it.

In an embodiment of the security system, the known area of said periphery of said image associated with said particular subset of said plurality of detection apparatus comprises an area wherein said particular subset of detection apparatus would detect.

In an embodiment of the security system, the known area of said periphery of said image associated with said particular subset of said plurality of detection apparatus comprises a preset area associated with multiple particular subsets of said plurality of detection apparatus.

In an embodiment of the security system, the video viewing device stores said image generated by said lens upon receipt of said image from said monitor.

In an embodiment of the security system, the monitor stores said image generated by said lens.

In an embodiment of the security system, the user can select other areas of said image generated by said lens after receipt of said image from said monitor to view on said video viewing device.

In an embodiment of the security system, the user can transmit said image from said video viewing device.

In an embodiment of the security system, the image comprises at least a portion of a video.

In an embodiment, the security system further comprises two-way audio communication between said monitor and said video viewing device.

### BRIEF DESCRIPTION OF THE DRAWINGS

FIG. 1 provides a front perspective view of an embodiment of a monitor of the present invention.

FIG. 2 provides a front view of the embodiment of FIG. 1.

FIG. 3 provides a left side view of the embodiment of FIG. 1.

FIG. 4 provides a right side view of the embodiment of FIG. 1.

FIG. 5 provides a rear view of the embodiment of FIG. 1.

FIG. 6 provides a top view of the embodiment of FIG. 1.

FIG. 7 provides a bottom view of the embodiment of FIG. 1.

FIG. 8 provides a single frame photograph of the entire 360 degree image recorded by the camera.

FIGS. 9A, 9B, and 9C provide a progression of photographs showing the 360 degree image of FIG. 8 being segmented to provide for a human understandable trigger image.

FIG. 10 provides an embodiment of how the trigger image of FIG. 9C can be presented to a user.

FIG. 11 provides a general block diagram of operable components of an embodiment of the monitor.

FIG. 12 provides a general indication of how six detection regions may be defined using three detection systems in a monitor.

FIGS. 13-15 provide screenshots of certain screens in a mobile device software “app” that can be used to receive data from a monitor.

### DESCRIPTION OF THE PREFERRED EMBODIMENT(S)

This disclosure is intended to teach by way of example and not by way of limitation.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

For purposes of this disclosure, there will also be significant discussion of a special type of computer referred to as a “mobile communication device” or simply “mobile device”. A mobile device may be, but is not limited to, a smart phone, tablet PC, e-reader, satellite navigation system (“SatNav”), fitness device (e.g. a Fitbit™ or Jawbone™) or any other type of mobile computer whether of general or specific purpose functionality. Generally speaking, a mobile device is network-enabled and communicating with a server system providing services over a telecommunication or other infrastructure network. A mobile device is essentially a mobile computer, but one which is commonly not associated with any particular location, is also commonly carried on a user's person, and usually is in near-constant real-time communication with a network allowing access to the Internet.

As will be appreciated by one skilled in the art, some aspects of the present disclosure may be embodied as a system, method or process, or computer program product. Accordingly, these aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory. The term “app” may be used to generally refer to a particular software element, of any kind, which is designed specifically to run on a mobile communication device.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “real-time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real-time” does not literally mean the system processes input and/or responds instantaneously, but rather that the system processes and/or responds rapidly enough that the processing or response time is within the general human perception of the passage of time in the operational context of the program. Those of ordinary skill in the art understand that, where the operational context is a graphical user interface, “real-time” normally implies a response time of no more than one second of actual time, with milliseconds or microseconds being preferable. However, those of ordinary skill in the art also understand that, under other operational contexts, a system operating in “real-time” may exhibit delays longer than one second, particularly where network operations are involved.

Within this disclosure, it should be recognized a “360 degree field of view” or similar terms are used to refer to the generally horizontal dimension. Most actions taken by humans which would relate to unauthorized activity in a residence are confined to being done by a person either in contact with the floor, or very close to contacting it due to the force of gravity being essentially universal throughout earth. While burglary can occur with elaborate rappelling or tunneling mechanisms, in many respects this type of burglary is confined to extremely high value theft (where the present system would not be readily useful) or Hollywood fiction. Thus, it is generally considered that a system which can view in 360 degrees horizontally (that is as defined based on being generally planar to the surface of the earth) will generally be able to view pretty much an entire room, residence, or other defined area or structure.

This concept of “360 degree viewing” also applies even though the embodiments discussed herein can also view in the third dimension. In particular, the cameras discussed herein are indicated to have a 360 degree field of view when the actually image an area which commonly corresponds to just over a hemisphere in three dimensions. The terms are used because imagery of a 360 degree plane, while it will generally also include some imagery at least in one direction (above or below) the plane, is effectively the only specific element of the present camera and lens arrangement and the camera and lens of the described embodiments can have a field of view of any value in the vertical plane and still be part of monitoring systems as discussed herein.

The home monitor, intrusion detection, or more generically “security” systems discussed herein are generally useable without the need to install electronics into a residence and provide for 360 degree viewing and recording as well as the ability to quickly make a 360 degree initial image interpretable to a human user. However, temporary installation of such systems is not required and permanent installation may be preferred in certain embodiments. The system generally comprises two major pieces: a detection module or monitor (100) and a remote viewing and or storing device (823) which will commonly be a mobile device such as a smartphone or tablet computer at the location of the user of the system.

The system generally comprises at least one and generally a plurality of monitors (100) each of which can include detection apparatus such as a camera, infrared (IR) detector, motion detector, or microphone connected with a processor for interpreting signals and is simply plugged into an available power source, such as a wall outlet, or is provided with a self-contained power supply. The system will generally utilize the signals generated by the monitor (100) to image and provide a record of an intrusion or other security trigger event and/or to provide deterrent mechanisms to an intrusion generally by sending video to a remote location such as a user's mobile device which may act as the storing and viewing device (823). The deterrent effect is commonly obtained if the device is visible prior to a burglary being attempted or if the device can warn that image capture is occurring to reduce the duration or impact of the event. The system, in other embodiments, may include additional components such as remote computer servers, storage systems, and the like to allow for more robust storage, processing, and the like remote from the monitor and user device, but these are not required.

While deterrent systems generally are designed to warn a burglar or potential burglar that the system is present and has been triggered (e.g. lights or sirens), it is contemplated in an embodiment that deterrent mechanisms can be included which may be remote (e.g. recording video to a remote location) and unknown. While such a system as this does not necessarily deter the initial burglary event (e.g. the breaking-in), such systems still provide deterrence as a burglar, upon seeing the system, can be made to understand that they have already been detected in a manner that cannot be readily avoided. Therefore, the burglar can be deterred from taking further action as they will quickly flee to avoid responding authorities or creating additional evidence against themselves. In an embodiment, an alert or siren has a range of about 75 to about 120 decibels.

It should also be recognized that the security systems contemplated herein do not have to be used solely to deter burglary. They can also provide general monitoring technology and/or crime detection that is not specific to burglary. For example, they can be used to check on pets, allow for children to notify parents that they have arrived home, allow a remote homeowner to communicate with a maid or other contractor working at their residence, or to detect and potentially prevent child abuse from a nanny among a number of other things.

The systems and methods discussed herein are useable in virtually any type of detection or monitoring situation, but are particularly useful in locations where the resident cannot make physical permanent changes to the location. Generally, this is because they are a temporary resident there. This can include, but is not limited to offices, dorm rooms, hotels, and rental properties. The system generally utilizes existing network infrastructure to provide for some of its functions and therefore does not require a specialized installation, however, it may be used in specialized installations including dedicated network structures. When used without purposefully installed network infrastructure, the system is generally considered “standalone”. In particular, the monitor (100), which is the only portion of the system generally present at the residence, can draw power from standard wall outlets and can communicate with remote locations using existing Wi-Fi™, Bluetooth™, cellular, or other wired or wireless communication networks that are already in place in the residence instead of needing dedicated systems.

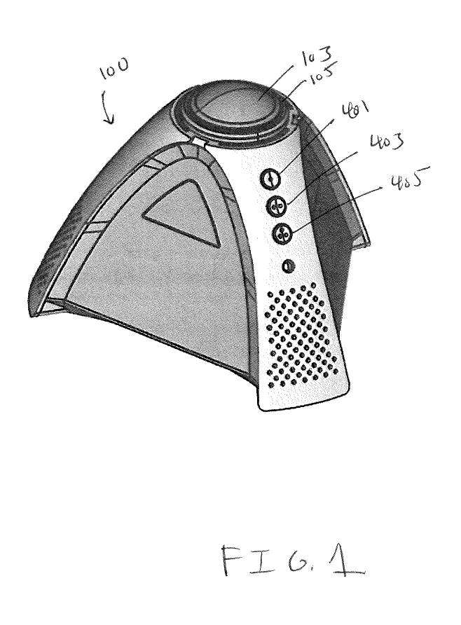

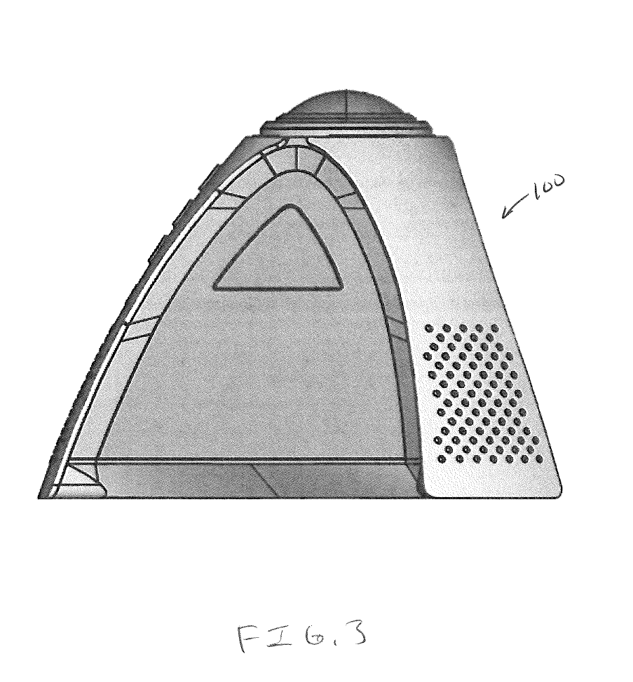

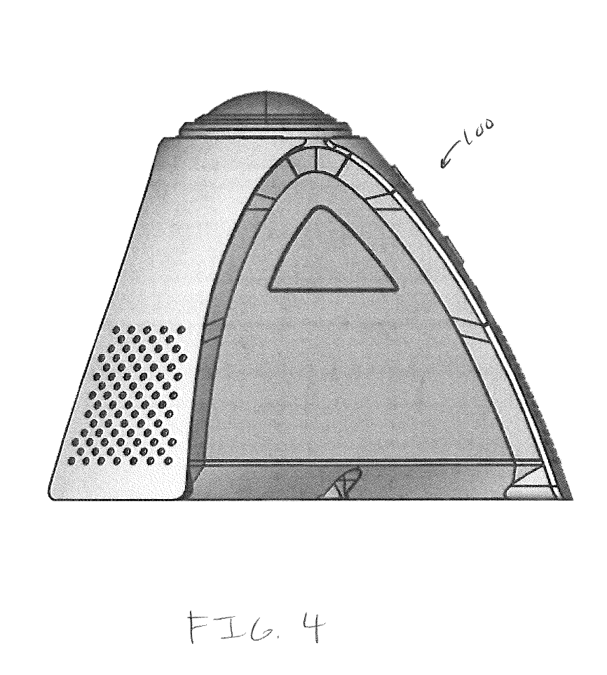

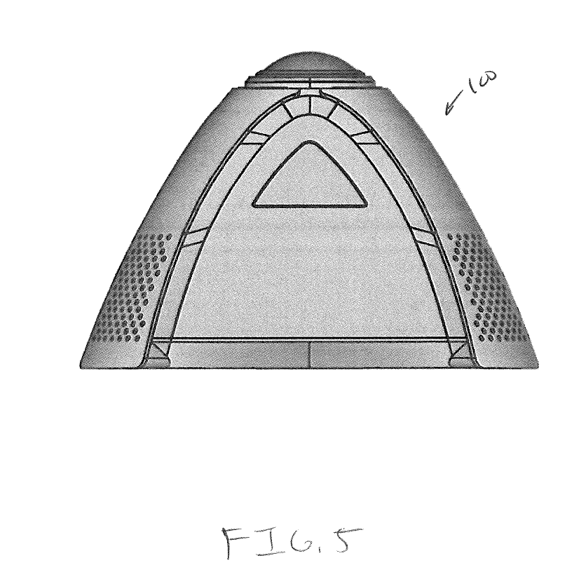

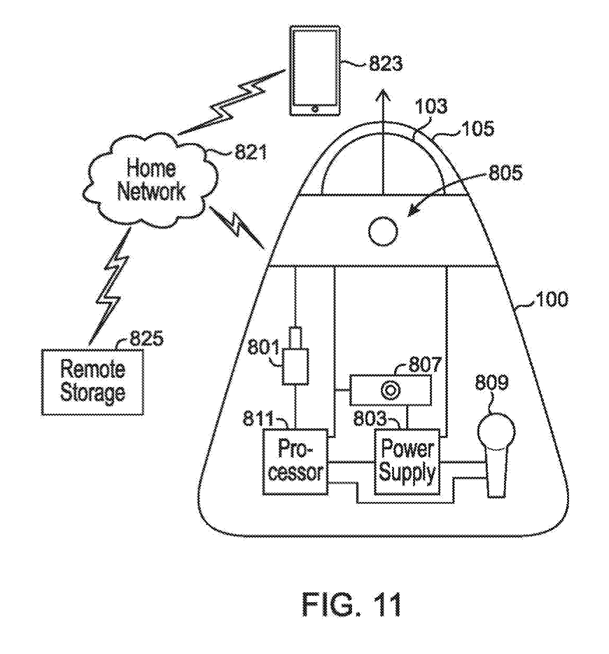

FIGS. 1-7 show multiple views of a first general embodiment of a monitor (100) of the present invention. FIG. 11 provides a general block format overview of internal components of the monitor (100). The monitor (100) will generally include a communication system such as antenna (801) which is capable of communication through an established communication network, such as, but not limited to, a home wireless (e.g. Wi-Fi™) router and network, a cellular communications network, a Bluetooth® capable device (e.g. a cellular phone), or via connection to a wired communications network such as phone line, cable TV line, or home internet cable. The monitor (100) will generally be a self-contained device which will usually be configured to be simply plugged in to power and connected to an existing network. Generally, power will be from a standard wall outlet but in alternative embodiments a power supply (803) such as, but not limited to, a battery pack, capacitor, solar panel, or kinetic storage device may be provided instead of or in addition to line power. Connection to a wall outlet may be via a standard power connector (701).

The monitor (100) will generally include some form of detection apparatus (807). The detection apparatus (807) is a component whose purpose is to detect a signal indicative of an intruder or similar event that indicates notification of the user is appropriate. Generally, the detection apparatus can comprise a visual apparatus (regardless of light spectrum), such as a camera, motion detector or IR detector, and/or a sonic apparatus such as a microphone (809) or ultrasound system.

In the depicted embodiment of FIGS. 1-7, multiple such detection apparatuses (807) may be combined together and multiple detection apparatus (807) are used to provide different fields of view. In particular, the block diagram of FIG. 11 will generally comprise a detection apparatus (807) associated with each of the largest faces of the device of FIGS. 1-7 and therefore really only illustrates a single side of the monitor (100). This can provide the monitor (100) with three separate detectors (807) each of which has a different, and often partially overlapping, field of view from the other detectors (807). The detection apparatus (807) will commonly operate to detect unexpected motion or another situation out of the ordinary.

The detection apparatus (807) will generally be paired with a processor (811) which is capable of interpreting the output of the detection apparatus (807) and making a determination if the detected signal (e.g. light wave or sound wave return) is indicative of a situation where user input is warranted (such as a suspected intruder), or of something else. For example, a motion detector-paired processor (811) may be able to determine if a signal is sufficiently large and moving in an expected fashion to represent a human being, as opposed to the signal being generated by a family pet (which would be much smaller and may move in a different fashion) or of a fly which has landed on the monitor (100). Similarly, such a system may be able to detect that the motion is that of a human as opposed to drapes being moved by the activation of a central heating system or simply changing IR signals due to distribution of heated or cooled air within the room.

In addition to a detection apparatus (807), the system may include a recording apparatus. This may be within the monitor (100), but generally will not be or at least, if present in the monitor, will provide duplicative storage to a storage system outside the monitor (100). Instead, the communication system (801) will generally be used to allow for the feed from the detection device(s) to be recorded remotely via transmission from the monitor (100). This can allow the detection by the monitor (100) to serve as evidence and to provide additional detail to a human user of the system should such feed be provided and/or recorded on their remote device (823) without risk of the storage media being lost as part of the intrusion. Depending on embodiment, the user's device (823) can be used to store the recording and/or alternative remote storage (825) may be used to provide increased available storage, security, and robustness.

The monitor (100) will also generally comprise a camera (805) such as a VGA camera or a High Definition or “HD” camera although any type of camera can be used. HD cameras will often be preferred due to improved resolution which can assist in clarity of the image when modified as discussed below. In a further embodiment, the camera (805) is connected with the wireless communication system (801), over which the camera feed is streamed or transmitted. Such wireless communication system may be, include, or utilize a wireless communications protocol and corresponding hardware implementing same in the IEEE 802.11 family of protocols. Video compression may also be utilized in an embodiment to increase video throughput while consuming less bandwidth. By way of example and not limitation, an embodiment may utilize a video coding format, such as H.264 or MPEG-4. In an embodiment, the camera (805) will be provided with a lens (103) may be positioned under a removable or other covering (105), which protects the lens (103) and improves the aesthetics of the device. In an embodiment, the removable covering (105) is made of glass or another translucent or transparent material. In another embodiment, the removable covering (105) may be tinted to assist with elimination of glare or to provide particular filtering or color enhancement.

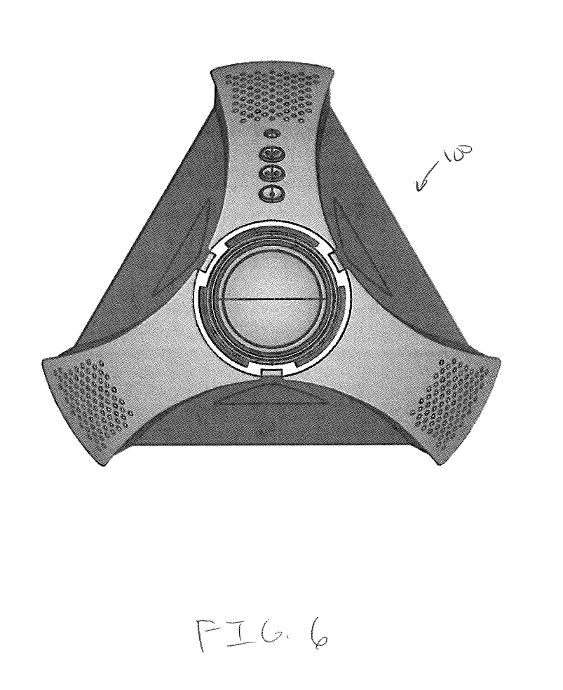

The monitor (100) is designed to be positioned in a fashion where camera (805) will have a generally unobstructed 360 degree view in the generally horizontal plane of the target area to be monitored. Thus, the camera (805) will generally have a “fisheye” type lens (103). The monitor (100) is generally designed to rest flat on a horizontal surface on its base (the base is shown in FIG. 7) with the camera (805) lens (103) aimed upward (out of the page in FIG. 6). The camera (805) lens (103) will generally have at least 180 degrees of vision around the vertical axis (V) based on the shape of the lens (103). In alternative embodiments, it has at least 200 degrees of vision, at least 210 degrees of vision, at least 220 degrees of vision, or at least 230 degrees of vision around the vertical axis (V).

As the lens (103) is aimed upward, the image seen from the lens (103) will be centered on the point of the ceiling directly above the monitor (100) and the image will extend to the edges which are generally either generally horizontal to the ground or may be slightly above or below horizontal (depending of the vision arc of the lens (103) and the position of the housing). In the depicted embodiment, the field of view at the periphery is generally just below the horizontal plane. This allows for the monitor (100) to be placed on a table or similar object and generally have vision to the floor at a distance from the table, but generally not image the top of the table in most cases.

By having the lens (103) arranged in this fashion, there are a number of advantages. The first is that the monitor (100) will generally have in its field of view, at any instant, any object that would trigger any detection apparatus(s) (807) since it is effectively imaging everything within the area. The second is that the monitor (100) can be simply placed on a horizontal surface facing upward instead of having to be hung from the ceiling as has traditionally been the case with security cameras that utilize a wider field of view. Hanging a device from the ceiling requires at least minimal installation which may not be possible in certain circumstances. For example, it would generally not be allowed in a hotel room and may not be allowed in rental housing scenarios or dorms. Instead, the monitor (100) may simply be placed on a piece of furniture, or even on the floor, to provide a relatively unobstructed view of a room.

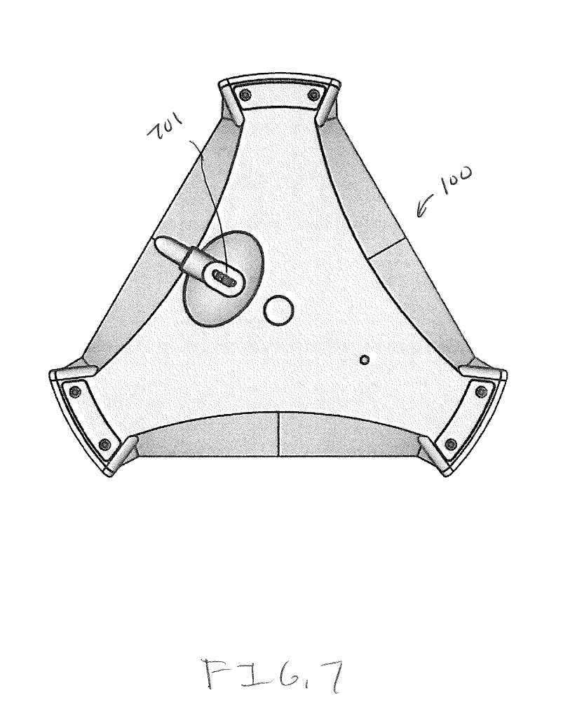

The output of the camera (805) can be seen in FIG. 8, and, as should be apparent from this FIG. 8, an advantage of the monitor (100) using a wide angle lens (103) of the types contemplated above is that it does not require the camera (805) to swivel toward a triggering activity as determined by the detection apparatus (807). Instead, the camera (805), upon being triggered to record, will immediately record its entire view range which includes the area of detection, as well as all other areas visible to the camera. This includes basically the entire area around the monitor (100) except for below it. In this way, it is not possible for an intruder to dodge the view of the camera (805) by moving faster than the camera (805) can mechanically rotate to face the area of detection. Instead, the intruder is caught on camera (805) immediately as soon as the camera (805) is triggered regardless of where they are in the room.

While an intruder obviously can hide under the monitor (100), the key is that the monitor (100) can be positioned so there is no normal room access located in this area and the intruder will trigger the recording before they can get there. Should there be a need to record below the monitor (100) it should be recognized that in an embodiment, a second monitor (100) can be inverted and their bases connected together, this would provide a full spherical field of view around the monitors (100). Similarly, if a lens existed which was capable of full sphere imagery, it would also be suitable for use in an embodiment of the monitor (100).

The monitor (100) can even go further than just recording triggering imagery. In such an embodiment, the image from the camera (805) may actually be recorded for a short continuously moving window of time immediately prior to any detector (807) being triggered. Basically, the system can keep the last 5-10 seconds of video recorded in memory at all times with this window being overwritten as time progresses by future windows. Upon a detector (807) triggering, the system, therefore, has a video recording not only of the entire room immediately after triggering, but has a recording of the trigger event itself (and a few seconds prior). In this way, it is very difficult for the system to be triggered without having a video record of what triggered the system.

The above and much of this disclosure contemplates the occurrence of a trigger event. In most security systems, the system is on and functioning at all times but does not record unless it is armed. The system is an armed by the user which means that they want it to actually detect occurrences which could be indicative of a problem. This often occurs because they are leaving the house, for example, so they want to know what is occurring at the house when they are not there (and they do not want to be constantly triggering the system when they are there). In most cases, once armed, the monitor (100) will respond to a certain occurrence or pattern of occurrences which, based in its design and programming, are expect to possibly be the warning situation the monitor (100) is expected to detect. Any of these can be a triggering event. For example, should the monitor (100) detect motion in an empty room, this will often be a triggering event as there is not expected to be motion. Similarly, if the room was quiet and a loud sound was detected, this could also be a triggering event.

In many respects, the concept of a triggering event is a recognition that most of the time that a security issue arises, the current steady state of an area is altered. As a simple example, one generally cannot steal something from an area unless they enter the area. Any event potentially indicative of such a security issue arising can be a trigger event as contemplated herein. It should also be recognized that trigger events can involve sophisticated processing of image, sound, or any other input. For example, a loud sound may only comprise a triggering event if it was interpreted by an automated sound processing system to be breaking glass or splintering wood for example.

It should be readily apparent that a triggering event is often the particular activity that needs to be reviewed to determine if it creates a security issue. For example, breaking glass could occur because of a window being broken (a clear security issue) or because a cat knocked a vase off the windowsill (not a security issue although something that may still be of interest). The general recognition of the present disclosure, however, is that the triggering event is generally an event of interest for review. That is, if there are three windows in a room, one is interested in determining from which window the sound of breaking glass occurred more so than what is happening at the other windows at the time that sound occurred. However, a triggering event may also generate an area of interest elsewhere. For example, if a room only has a single access point, any loud sound, regardless of direction, may be an indicator to see what is happening at the access point.

As can also be seen from FIG. 8, however, the view of a camera (805) using a fisheye lens with such a large field of view is not readily interpretable by the human eye because the view is so much different from that of normal human vision. A normal human has a total angle of view of generally around 55 degrees to each side of center (110 degrees), but binocular vision is only around 30 degrees on each side of center (60 degrees total). Thus, the vision of the camera (805) is more than double a human's normal vision and up to 4 times the view a normal human is used to using regularly. Further, because the lens (103) is aimed up, it is also not directed in a manner that humans are used to. Humans primarily view in the binocular portion of their vision (which is directly in front). The edges of vision (peripheral vision), including upward, are generally only used to detect movement or other major activity and humans will turn their head to center a peripheral activity if they wish to view it. The camera (807), however, as a computing device, is not bound by the limits of human vision and can record the image (300) (such as that of FIG. 8) which is difficult for a human to view and interpret.

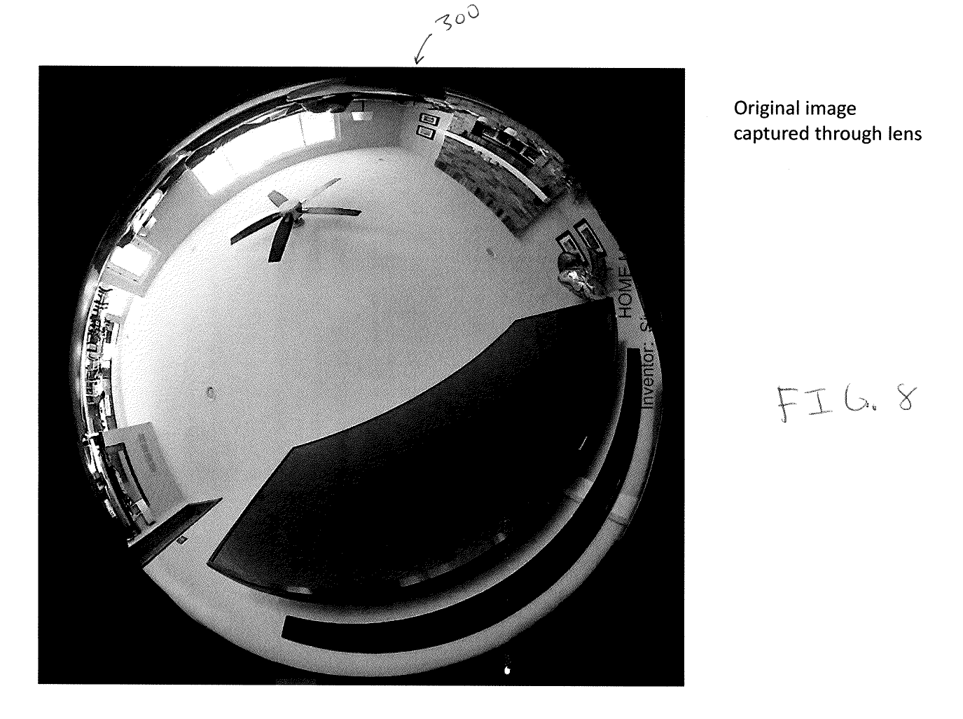

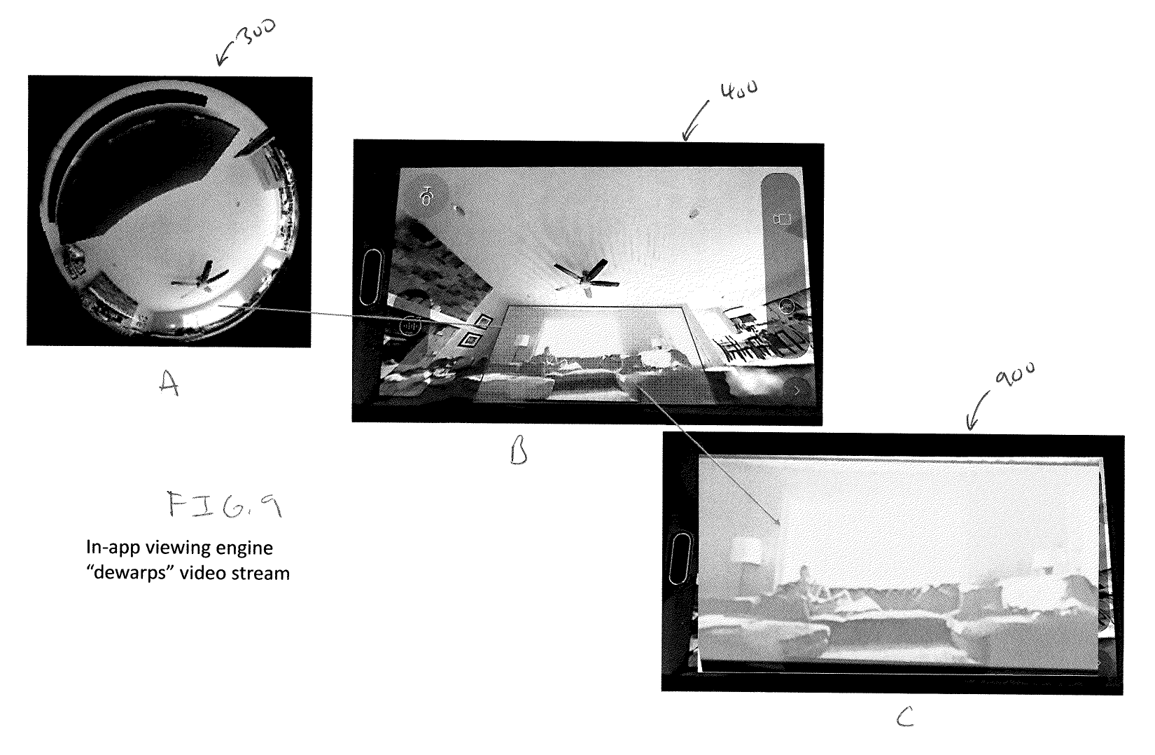

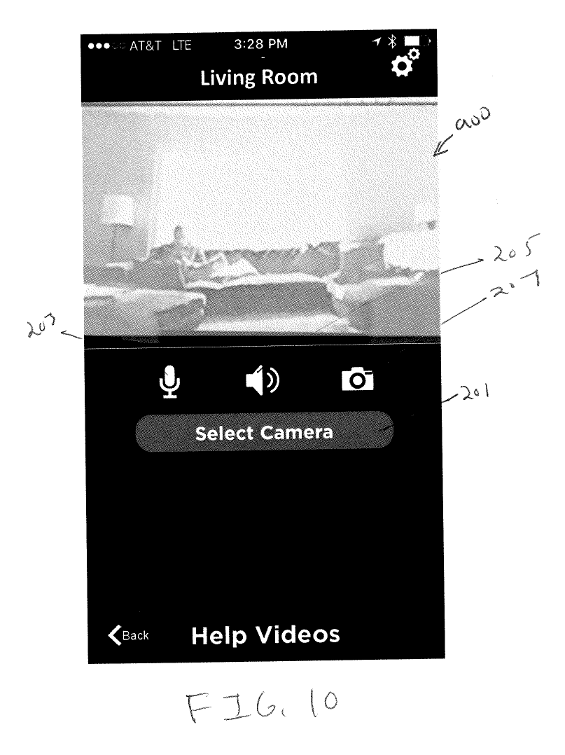

The concern with the limitations of human interpretation of the image (300) is that it can take a human a relatively long time to determine what the image (300) shows, if it is a relevant trigger, and then how to respond to it because the triggering event is usually at the periphery of the image (300), and distorted by the lens (103). This can allow for an intruder to actually damage the monitor (100) so that the ability to record or monitor is lost before the user can interpret it. This problem is further compounded because the image (300) will often be viewed on a mobile device (823) and, therefore, will often be relatively small with the entire image viewing area being less than 5 inches on its longest dimension. FIG. 9A actually shows an example of how seeing any detail in the figure, particularly at the periphery where the image (300) is distorted in a fashion compared to normal vision is extremely difficult in a small image because the relevant details are at the periphery, distorted, and small.

FIGS. 8, and 9A-9C provide a relevant place to discuss interpretation. In the enlarged FIG. 8, the hypothetical trigger (based on movement) is human movement and specifically movement of the human sitting on the couch. This person is visible in the image (300) of FIG. 8, but they are highly distorted and not immediately discernable as a human at all. As discussed, the problem is even more pronounced in image (300) as shown in FIG. 9A which is a more relevant size. However, in an embodiment of the present system augmented or virtual reality systems and dewarping technology may be used to improve the immediate viewability of portions of the image (300) and to do so in real-time or near real-time.

While the above contemplates a trigger event of movement being detected and that the target portion of the image (300) is where the movement is detected, this is by no means required and different triggers and or portions of the image (300) may be selected. For example, in various embodiments, the trigger event can be, but is not limited to, detected movement, a specific external event (e.g. depression of remote trigger mechanism or activation of a button in a software app), an internal event (e.g. depression of button (401), (403), or (405)), the occurrence of a specific time (e.g. that it is currently 1:00 am GMT), a detected face (e.g. through facial recognition software), a specific color (e.g. that there is red in the image), a specific shape or form (e.g. that of a human or animal), detection of a particular sound or sound volume, or any combination of these.

Similarly, in various embodiments, the target portion of the image (300) which is expanded into image (400) may be, but is not limited to, the subset portion of the image including the trigger event (e.g. the portion where the movement, color, face, or form appears), a fixed portion (e.g. the same specific quadrant) which may be defined by the device or a user, a subset portion of the image that contains a specific element of interest even if it is not the trigger event (e.g. the portion that contains a human face when the button (401) is depressed), the portion aligned with a specific sound detection, or any combination or interplay between these. Generally, this subset portion will be at the periphery but that is by no means required. In an embodiment, an element of the system (100) is that the trigger causes the system to select a specific portion of image (300) as image (400) because that image (400) includes a specific element which is likely to be of interest to a human user due to the occurrence of the trigger event. This correlation between trigger event and image portion may be user defined or selected by the system (100).

In FIG. 9B, the relevant section of FIG. 9A (the subset portion at the periphery of the image (300) which includes the movement that triggered the system (100) to begin sending images) has been expanded into image (400) and distortion has begun to be removed by the onboard processor of the mobile device (823) which is displaying the image (400). This is further refined in the image (900) of FIG. 9C which now shows quite clearly a human sitting on a couch and the relevant items of interest even in an image (900) which is of relevant size to the display of many mobile devices as shown in FIG. 10. It is important to recognize that the selection of a viewable image (900) in the embodiment of FIG. 9 is simply a software function which provides a portion of the available image (300) modified to make it more understandable to human vision, and that the system, usually at the remote device, will do this modification generally in real-time or near real-time and generally automatically in response to the trigger occurring.

This is different from using a moving camera where the image shown is always the entire image the camera views and the camera lens may move within the room. Instead, the present system shows a portion of the entire image (300) which has been better adapted for human interpretation as image (900), and may adjust that portion to provide for better viewability. However, the entire image (300), which shows the entire room, is generally still obtained and recorded as this provides dramatically more information than can be provided by a moving camera.

In order to assist in accelerating human identification of the activity and to allow the user to respond fast to the detector (807) detecting a triggering event, while the entire image (300) of FIG. 8 may be stored in memory for later reference and possible evidential use, the system, in an embodiment, will preferentially select an image (900) more akin to that of FIG. 10 to initially provide the user when the triggering event occurs. The image (900) provided will generally be selected so as to correspond with showing whatever is detected by the detector(s) as the triggering event or that corresponds to a specific image based on the triggering event. This arrangement, however, is not required and the user may choose where to select an initial viewed image (900) by being provided the entire image (300). This can allow a user to, for example, review a particular part of the image (300) of interest to them.

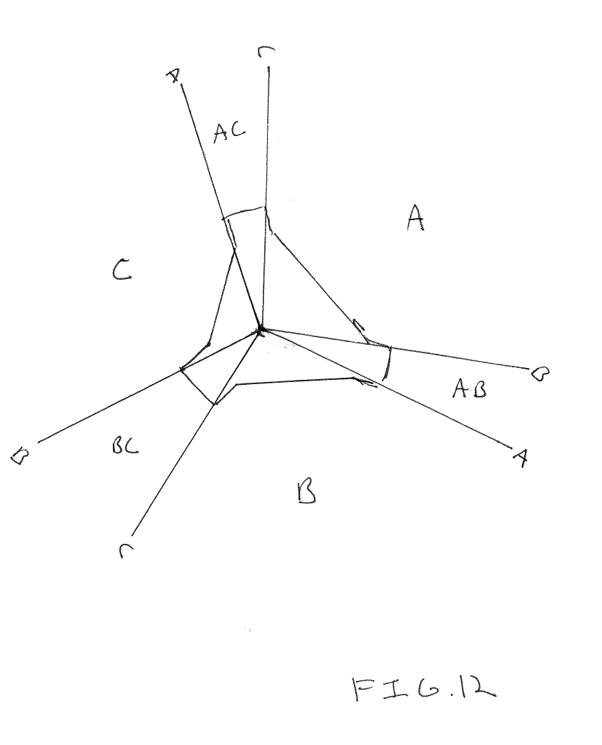

As discussed above, the monitor (100) preferably includes multiple detectors each of which has a different field of view. FIG. 12 provides for the concept of three different monitor fields of view (A), (B), and (C). In order to determine what portion of the image (300) the monitor will generally select to provide to the user as the initial view (900), the monitor (100) will generally utilize the portion of the image (300) at the periphery of the image (300) which corresponds to the field of view of the subset of detector(s) which was activated. As shown in FIG. 12, the detection field of view when viewed looking down from above (the view of FIG. 6) of multiple detectors (807) may overlap (they may also be mutually exclusive in an alternative embodiment). In the embodiment of FIG. 12, there are 6 different trigger areas (of unequal size).

In particular, the six areas of triggering correspond to the 3 areas (A), (B), and (C) which are only within the field of view of a single detector, and the 3 areas (AB), (BC), (AC) which are within the field of view of two detectors (807). Thus, if a single detector (807) is tripped, the area of the image (300) corresponding to the view area of that detector (807) will often be the one provided. If two detectors (807) are tripped simultaneously, the field of view covered by both will generally be provided instead and an area outside this field (as it is smaller) may also be provided to provide for a consistent image size. The correspondence of the subset of the detectors to the portion of the image need not be absolute, but it can allow for areas of interest to be quickly selected. Further, sending imagery from the periphery of the image will generally result in an image that corresponds to the view of a detector as that is the generally horizontal view of the monitor (100).

It should be recognized that image (900) provided can be further refined or selected within the computer logic and need not be specifically slaved to the triggered detector(s) (807). Specifically, the system can provide the field of view which is “tracking” the object of interest. In effect, the object, once identified can be centered in the provided image (900), and the provided image (900) can track to attempt to maintain the triggering object in the center.

It is important to recognize here that the tracking of the object and the field of view of the camera which is presented in image (900) does not represent the only video obtained or stored. Generally, the entire image (300) of FIG. 8 would be obtained and recorded regardless of the position of triggering. This allows for later review of the entire image (300), and for the user to navigate to other portions of it should they wish to do so. The portion selected is generally presented as an initial image (900) to assist in quicker comprehension of what is shown by a human user. The camera (805) is generally not limited to simply viewing a particular object of interest, but records everything and instead the user can simply review portions of it to provide for a more human vision friendly appearance.

The ability to not have to physically move the camera (805) to direct it towards the object of interest is particularly valuable should there be multiple objects of interest. It can be the case that objects of interest (or trigger events) occur simultaneously (in near real-time) in two different locations. In this situation, a moveable camera may have trouble as it attempts to track between the two different objects and may end up not actually ever viewing either due to computer confusion. In the present case, the reported image may simply be split-screened, may be switched rapidly between in order to show multiple trigger objects, or simply one or the other may be shown. This can allow for a much greater flow of information to a human user. It also provides a more robust recording.

Generally, should the system be triggered (e.g. the detector (907) detects a triggering event), the processor (811) will first perform any internal determination of if a user should be contacted or if the event does not qualify for some reason. Should the event be considered relevant, the processor (811) will generally activate the communication system (801) which will attempt to communicate with a human user and may also transmit the video image (300) to a remote location (either the mobile device (823) or another location (825)). The contact will usually be the person who purchased and installed the monitor (100) and therefore paired their mobile device (823) with it, but that is by no means required.

Specifically in such communication, the communication system (801) will often comprise electronics for accessing a known communication network (such as a home wireless network (821)) and transmitting information to a remote users mobile device (823) or other computer (825) using a standard communication protocol. The user of the device (823) is then able to review the information provided in the image (900) and determine if the “intruder” is, for example, just a child who arrived home early, or is actually someone unauthorized to be in view of the monitor (100). The user may then have an ability to react to the feed such as, but not limited to, by triggering audible and/or visual alarms at the monitor (100), initiating a call to law enforcement, or initiating a video recording to generate evidence against the burglar. In an embodiment, the feed itself can be live streamed to law enforcement allowing them to know, in near-real time, where the monitor (100) has seen the burglar. This can allow for a far more efficient police response.

Should the image (900) prove to be inconclusive to the user, the user may access the image (300) and then navigate within it in the depiction of FIG. 10. This may be performed using the camera selection button (201). This button (201) allows the user to back out to a view such as that of FIG. 8, or even to move their device (823) and have the image (900) change as if the device were a more standard camera with a more restricted (e.g. 60 degree field of view) lens.

FIG. 10 also shows an indication of possible response buttons upon triggering of the monitor (100). Specifically, a user may activate a microphone (809) and/or speaker in the monitor (100), which will allow them to speak through the monitor (100). This button (203) will commonly be used if the monitor (100) was triggered inadvertently by a family member returning home early, or something similar where the user (100) simply wants to communicate with the triggering event. However, it may also be used to speak directly to an intruder to inform them that they have been recorded. The monitor (100) in an embodiment, may provide full duplex audio communication in conjunction with single direction video communication. This can be useful in allowing the monitor to be used to check in on people in the residence. For example, it can allow a parent to monitor children, for the monitoring of a pet, or for communication with a contractor working on the home. As the video is one way, the individual in the residence will not know they are being monitored until the user wishes them to be in some embodiments.

Alternatively, the user may trigger an alarm button (205). This will commonly activate a high decibel siren or other audible or visual alarm to indicate to anyone around the monitor (100) that the monitor (100) has been triggered. Finally, the user may activate the camera button (207). This may serve to record the video locally or at another source or to take a single frame image and store it separately from the entire lens (103) image.

It is generally contemplated herein that the intrusion detection systems (100) described in this disclosure interacts in real-time or near real-time with a user's mobile device (823) via a software application or “app”. Embodiments of such an application (900) are depicted in FIGS. 10 and 13-15. The user device application (900) will generally run on a user device (823) using the native operating system and features of that device (823), and will generally include a user interface having user input and output or elements and components. Preferably, the user interface (900) utilizes graphical user interface components and elements, but the precise content of the interface will necessarily vary from embodiment to embodiment, and may also vary over time as design aesthetics and user preferences evolve and change.

In an embodiment, a user device application (900) includes a device (823) pairing or registration feature, with accompanying interface elements. This generally enables the application (900) to “pair” or otherwise synchronize or connect with the intrusion detection systems (100) described herein. For example, most modern-day consumer devices (823) support Bluetooth® pairing.

Alternatively, the application (900) may connect to or synchronize with the intrusion detection device (100), using a different wireless communications technique or protocol, such as Wi-Fi™ or other radio-based network communications protocols over a home network (821). This feature allows the application (900) to pair with the intrusion detection monitor (100) so that when the monitor (100) generates alerts or other signals to transmit to the application (900), the particular user device (823) for which the signals are intended are readily identifiable by the intrusion detection monitor (100). This may be done using, by way of example and not limitation, a MAC address, a network address, or a device serial number or other identifier.

The application (900) also allow for connecting to multiple monitors (100). This is particularly useful where the user is monitoring multiple devices (100) within a single residence, or where the user has multiple devices (100) in multiple residences.

In an embodiment, a monitor (100) is paired with the application (900) by connecting the monitor (900) to a power source, then connecting the monitor (900) to a wireless router. The monitor (900) is then added to the local network (821), including, without limitation, by using Wi-Fi™ Protected Setup (“WPS”), such as with push button configuration. In such an embodiment, the user selects the WPS button on the router, and a WPS button on the intrusion detection monitor (100), and WPS technology connects the monitor (900) to the router and the local network (823). The user may then download the application (900) and pair the application (900) with the monitor (900).

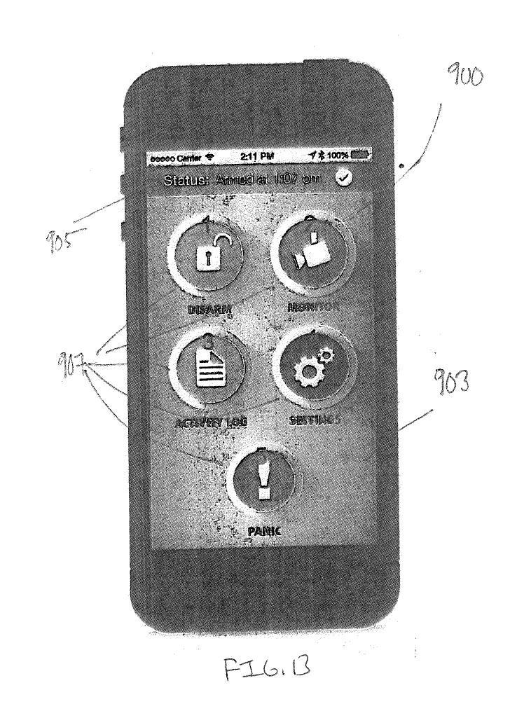

In an embodiment, the application (900) includes a “home screen” or other startup or default screen (903), which will generally appear when the application is initially started. An embodiment of a home screen (903) for use in the application is depicted in FIG. 13. In the typical embodiment, the home screen (903) will comprise output elements (905) showing the general status of the intrusion detection systems (100) being monitored by the application (900), or otherwise connected to or paired with the application (900). By way of example and not limitation, the home screen (903) may show (905) which devices (100) are armed or disarmed, when the device (100) was armed or disarmed, the location where the device has been placed, a thumbnail of the current image or video being captured by the device (100), an indicator of an on-line condition with the device (100), if any, a status bar (905), and so forth.

In an embodiment, the home screen (903) may further comprise user input components (907) allowing the user to quickly provide instructions, or access key information, without having to navigate through menus. By way of example and not limitation, such user input components (909) may include an arm/disarm button, a monitor button, an activity log button, a settings button, and/or a siren button. Although buttons are generally contemplated, another user input element (907) may be substituted for a button, including, without limitation, gesture-based input and/or voice-based input. Where appropriate, selecting or operating such user input components (907) may cause other screens to load or otherwise appear in the application (900).

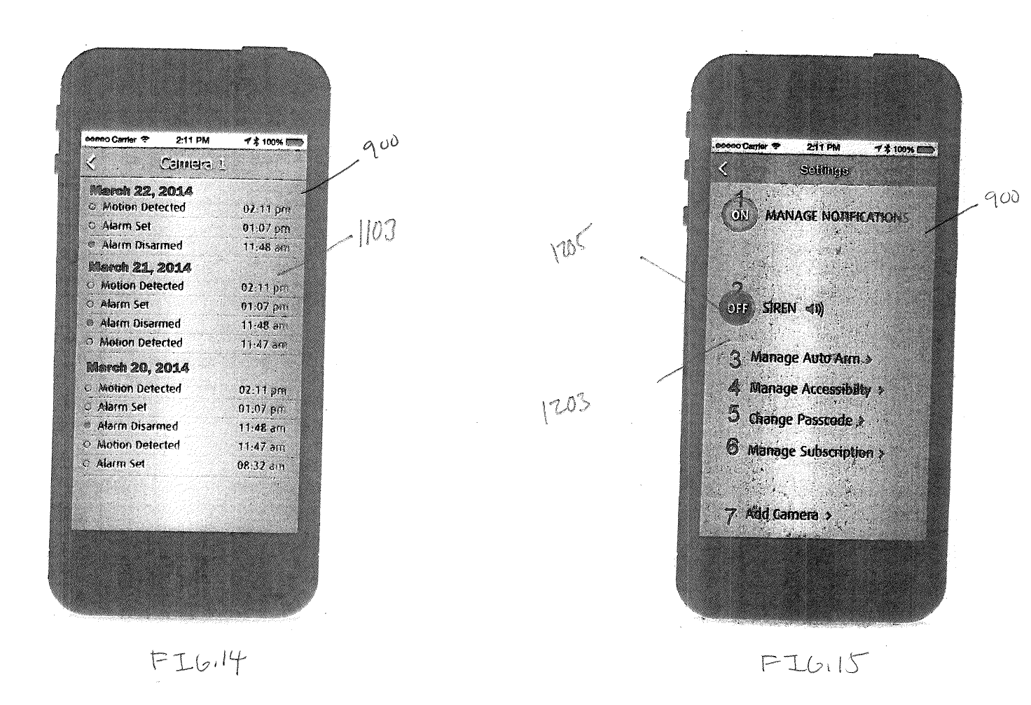

In another embodiment, the application may include an activity log screen (1103), which may appear or be accessible by selecting the activity log button on the home screen (903). An embodiment of an activity log screen (1103) is depicted in FIG. 14. The activity log (1108) may display to the user any activity pertaining to the monitor (100). In an embodiment, the activity log (1103) on this screen (1103) may contain data which is the same or similar as that displayed on the monitoring screen (1003).

In an embodiment, the application may include a settings screen (1203). An embodiment of a settings screen (1203) is depicted in FIG. 15. This screen (1203) may be accessed by selecting the settings button from the home screen (903). In an embodiment, the settings screen (1203) may comprise user input and output components, including, without limitation: siren on/off (1205); motion sensor settings (sensitivity, delay, etc.); LED indicator on/off; manage pass code; manage IR illumination; manage auto arm; manage accessibility; and/or manage subscription.

The application (900) may include other features or functions, including, without limitation, a manage auto arm screen, a manage accessibility screen, a manage subscription screen, a manage camera settings screen, a manage pass code screen, a pass code screen, and a screen for managing cameras or other intrusion detection systems within a particular device, or adding new monitors (100).

In an embodiment, the application (900) communicates with the intrusion detection system (100) to implement an auto arm feature. Because the intrusion detection system (100) can be used as a standalone device (100) without the use of intervening third-party servers or monitoring services, the intrusion detection monitor (100) is generally monitored and administered via a user mobile device (823). Because most modern smartphones and tablet computers and other user devices (100) include location technology, the approximate distance from the intrusion detection monitor (100) to the user device (900) can be determined. Thus, if the application (900) determines that the device (823) on which it is running is located more than some threshold distance away from the intrusion detection monitor (100), the application (900) can be configured to automatically arm the monitor (100), whether or not the user has remembered to do so. Thus, the user may simply leave his or her residence, and, as the user moves further away, the system (100) will automatically arm itself.

Auto arm can be done whether or not the application (900) is running in the foreground, using background application functionality. Alternatively, monitor (100) may itself implement this technology, such as by frequently communicating with the paired user device to request its location, and, if the location exceeds some certain threshold, the intrusion monitor (100) automatically arms itself. In an embodiment, the threshold distance is 25 meters, 50 meters, or 100 meters. In an alternative embodiment, the threshold may use alternative units, such as feet, yards, or miles. In a situation where multiple users are monitoring the same system (100), the auto arm feature may operate only if all users are determined to be at least some threshold distance away from the device.

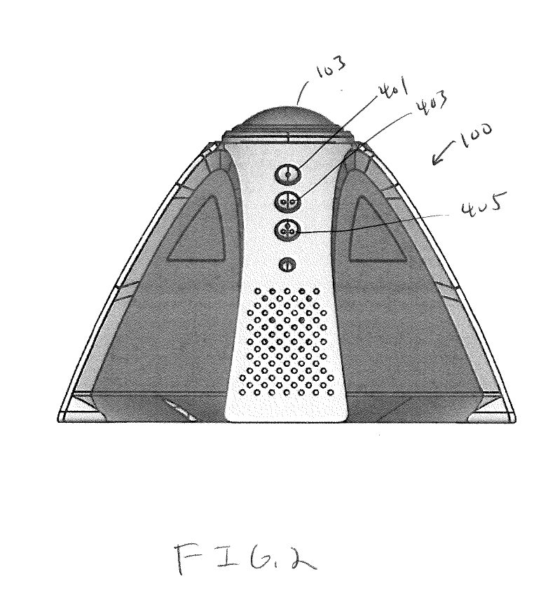

In addition to the various software features contemplated above which can be a portion of the app on the user's mobile device, the monitor may also incorporate certain features. Based on user interface, these will commonly be implemented using hardware buttons, but that is not required. As best shown in FIG. 2, the monitor may include a plurality of call buttons (401), (403), and (405) which can be used to call particular mobile devices which have been paired with the monitor (100) or which it otherwise has been trained to communicate with. These allow a person at the monitor (100) to quickly communicate with a user of the monitor (100). In an embodiment, these may be used, for example for a child to call a parent when they arrive home using the monitor (100). They may also allow for emergency personnel to quickly contact the various users when they arrive on-scene.

In an embodiment, when any of these buttons are activated, the monitor (100) will generally initiate communication with the associated user mobile device (823) and will generally simply activate the internal microphone (809) for immediate speaking communication. This allows for a person pressing the button (401), (403) or (405) to simply push and speak to the associated mobile device (823). The communication may then be recorded at the user's mobile device (823), which may notify the user of the communication as the user wishes, or it may initiate a two-way voice channel in any fashion known now or later discovered.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “sphere” are purely geometric constructs and no real-world component is a true “sphere” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A security system comprising:
a monitor including:
a wide angle lens, said lens being positioned so that a center of an image generated by said lens is generally above said monitor and a periphery of said image generated by said lens displays a 360 degree view in a horizontal plane about said monitor;
a communication system; and
a plurality of detection apparatus arranged about said monitor so that activation of any particular subset of said plurality of detection apparatus is associated with a known area of said periphery of said image; and
a video viewing device, remote from said monitor;
wherein upon activation of a subset of said plurality of detection apparatus, said monitor utilizes said communication system to transmit said image generated by said lens to said video viewing device;
wherein said video viewing device receives said image generated by said lens, and displays only said known area of said periphery of said image.

2. The security system of claim 1, wherein said plurality of detection apparatus includes at least one motion detector.

3. The security system of claim 1, wherein said plurality of detection apparatus includes at least one audio detector.

4. The security system of claim 1, wherein said video viewing device comprises a mobile device.

5. The security system of claim 1, wherein said mobile device comprises a smartphone.

6. The security system of claim 1, wherein said mobile device comprises a tablet computer.

7. The security system of claim 1, wherein said lens comprises a fisheye lens.

8. The security system of claim 1, wherein said lens has a field of vision of at least 180 degrees around a vertical axis relative to said horizontal plane.

9. The security system of claim 8, wherein said lens has a field of vision of at least 200 degrees around a vertical axis relative to said horizontal plane.

10. The security system of claim 9, wherein said lens has a field of vision of at least 210 degrees around a vertical axis relative to said horizontal plane.

11. The security system of claim 1 wherein said video viewing device dewarps said known area of said periphery of said image before displaying it.

12. The security system of claim 1 wherein said video viewing device enlarges said known area of said periphery of said image before displaying it.

13. The security system of claim 1 wherein said known area of said periphery of said image associated with said particular subset of said plurality of detection apparatus comprises an area wherein said particular subset of detection apparatus would detect.

14. The security system of claim 1 wherein said known area of said periphery of said image associated with said particular subset of said plurality of detection apparatus comprises a preset area associated with multiple particular subsets of said plurality of detection apparatus.

15. The security system of claim 1 wherein said video viewing device stores said image generated by said lens upon receipt of said image from said monitor.

16. The security system of claim 1 wherein said monitor stores said image generated by said lens.

17. The security system of claim 1 wherein said user can select other areas of said image generated by said lens after receipt of said image from said monitor to view on said video viewing device.

18. The security system of claim 1 wherein said user can transmit said image from said video viewing device.

19. The security system of claim 1 wherein said image comprises at least a portion of a video.

20. The security system of claim 1 further comprising two-way audio communication between said monitor and said video viewing device.
